(19) United States
(12) Patent Application Publication
(10) Pub. No.: US 2012/0057828 A1
(43) Pub. Date: Mar. 8, 2012

(54) OPTICAL TRANSMISSION MODULE AND METHOD FOR MANUFACTURING OPTICAL TRANSMISSION MODULE

(75) Inventors: Kazuhiro MITAMURA, Kanagawa (JP); Hideyuki YAMADA, Kanagawa (JP)

(73) Assignee: RENESAS ELECTRONICS CORPORATION, Kanagawa (JP)

(21) Appl. No.: 13/213,558

(22) Filed: Aug. 19, 2011

(30) Foreign Application Priority Data
Sep. 2, 2010 (JP) 2010-196975

(51) Int. Cl. G02B 6/36; B32B 37/14; B32B 37/02

(52) U.S. Cl. 385/78; 385/76; 156/60

(57) ABSTRACT

An optical transmission module includes a stem, a semiconductor laser element mounted over the stem, a cap fixed to the stem and hermetically sealing the semiconductor laser element, and an optical isolator arranged on an optical path of light emitted from the semiconductor laser element. The cap includes a tubular body, one end side of which is fixed to the stem, and a light transmitting section located on the optical path while closing an opening on the other end side of the body, and fixed to the body so as to keep hermeticity with the body. The optical isolator is arranged inside an area hermetically sealed by the cap.

This application is based on Japanese patent application NO. 2010-196975 filed on Sep. 2, 2010, the content of which is incorporated hereinto by reference.

### BACKGROUND

1. Technical Field

The present invention relates to an optical transmission module and a method for manufacturing an optical transmission module.

2. Related Art

As an optical module for optical transmission, for example, there exists one described in Japanese Laid-open patent publication NO. 2007-086472. The optical module in Japanese Laid-open patent publication NO. 2007-086472 includes a stem, a heat sink fixed to the stem, a semiconductor laser fixed to the heat sink, a cap fixed to the stem, a lens or a plain window held in the cap, and an optical isolator. The lens or the plain window is bonded to the cap through low-melting glass, and the semiconductor laser on the stem is hermetically sealed by the lens or the plain window and the cap. The optical isolator is arranged adjacent to the lens or the plain window outside the cap.

In addition, it is described in Japanese Laid-open patent publication NO. 2004-061870 that an optical isolator is provided in place of a hermetically sealing window in the optical module.

### SUMMARY

Incidentally, light emitted from the semiconductor laser has a predetermined spreading angle. The present inventors have recognized as follows. In the case of the structure of Japanese Laid-open patent publication NO. 2007-086472, the optical isolator is arranged adjacent to the lens or the plain window outside the cap, and therefore, in order to efficiently receive light emitted from the optical isolator, there is required an optical isolator of a size in accordance with the spread of the emitted light until the light reaches the lens or the plain window.

However, the optical isolator is a high-priced optical component, and the larger the size thereof, the further higher-priced it gets. Therefore, in the case of the structure of Japanese Laid-open patent publication NO. 2007-086472, cost of the optical isolator, and cost of the optical module, becomes high.

Meanwhile, in the structure of Japanese Laid-open patent publication NO. 2004-061870, hermetical sealing being performed by the optical isolator may cause deterioration in characteristics of the optical isolator.

As thus described, it has been difficult to suppress an increase in cost of the optical isolator, and cost of the optical module, while suppressing an adverse effect on the characteristics of the optical isolator.

In one embodiment, there is provided an optical transmission module, including a stem, a semiconductor laser element mounted over the stem, a cap fixed to the stem and hermetically sealing the semiconductor laser element, and

an optical isolator arranged on an optical path of light emitted from the semiconductor laser element,

wherein the cap includes

a tubular body, one end side of which is fixed to the stem, and

a light transmitting section located on the optical path while closing an opening on the other end side of the body, and fixed to the body so as to keep hermeticity with the body, and

the optical isolator is arranged inside an area hermetically sealed by the cap.

According to the optical transmission module, the optical isolator is arranged inside the area hermetically sealed by the cap (tubular body section and the light transmitting section). Therefore, as compared with the case of the optical isolator being arranged outside the cap, the semiconductor laser element and the optical isolator get close to each other. Then, during the course of spreading of light having been emitted at a spreading angle, the optical isolator receives the emitted light. Therefore, as compared with the case of the optical isolator being arranged outside the cap, an area of the optical isolator can be made small. As a result of being able to make the area of the optical isolator small, it is possible to suppress an increase in cost of the optical isolator, and cost of the optical transmission module.

Further, with the optical isolator being arranged inside the area hermetically sealed by the cap, hermetical sealing need not be performed by the optical isolator. Therefore, it is possible to prevent occurrence of deterioration in characteristics of the optical isolator caused by the optical isolator performing hermetical sealing.

In short, it is possible to suppress an increase in cost of the optical isolator, and cost of the optical module, while suppressing an adverse effect on characteristics of the optical isolator.

In another embodiment, there is provided a method for manufacturing an optical transmission module, including mounting a semiconductor laser element over a stem, fixing a cap to the stem and hermetically sealing the semiconductor laser element, and arranging an optical isolator on an optical path of light emitted from the semiconductor laser element, wherein the cap includes a tubular body, and a light transmitting section which closes an opening on one end side of the body and is fixed to the body so as to keep hermeticity with the body, the other end side of the body is fixed to the stem in said fixing the cap, and the optical isolator is arranged inside an area hermetically sealed by the cap in said arranging the optical isolator.

According to the present invention, it is possible to suppress an increase in cost of the optical isolator, and cost of the optical module, while suppressing an adverse effect on characteristics of the optical isolator.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a sectional view of an optical transmission module according to a first embodiment;

FIGS. 2A and 2B are views illustrating an arrangement of an optical isolator with respect to a cap;

FIG. 3 is a view schematically illustrating an aspect of propagation of emitted light;

FIG. 4 is a sectional view of an optical transmission module according to a second embodiment;

FIG. 5 is a sectional view of an optical transmission module according to a third embodiment;

FIG. 6 is a sectional view of an optical transmission module according to a fourth embodiment;

FIGS. 7A and 7B are views illustrating an arrangement of an optical isolator with respect to a cap;

FIG. 8 is a sectional view of an optical transmission module according to a fifth embodiment;

FIG. 9 is a sectional view of an optical transmission module according to a sixth embodiment;

FIG. 10 is a sectional view of an optical transmission module according to a seventh embodiment;

FIGS. 11A and 11B are views illustrating an arrangement of an optical isolator with respect to a sub-mount;

FIG. 12 is a sectional view of an optical transmission module according to an eighth embodiment;

FIG. 13 is a sectional view of an optical transmission module according to a ninth embodiment;

FIGS. 14A and 14B are views for explaining an optical transmission module according to a first modification;

FIGS. 15A and 15B are views for explaining an optical transmission module according to a second modification;

FIGS. 16A and 16B are views for explaining an optical transmission module according to a third modification;

FIGS. 17A and 17B are views for explaining an optical transmission module according to a fourth modification;

FIGS. 18A and 18B are views for explaining an optical transmission module according to a fifth modification;

FIGS. 19A and 19B are views for explaining an optical transmission module according to a sixth modification; and

FIGS. 20A and 20B are views for explaining an optical transmission module according to a seventh modification.

### DETAILED DESCRIPTION

The invention will be now described herein with reference to illustrative embodiments. Those skilled in the art will recognize that many alternative embodiments can be accomplished using the teachings of the present invention and that the invention is no limited to the embodiments illustrated for explanatory purposes.

Hereinafter, embodiments of the present invention will be described using the drawings. It is to be noted that in all of the drawings, similar constitutional elements are provided with the same numeral, and a description thereof will not be repeated.

### First Embodiment

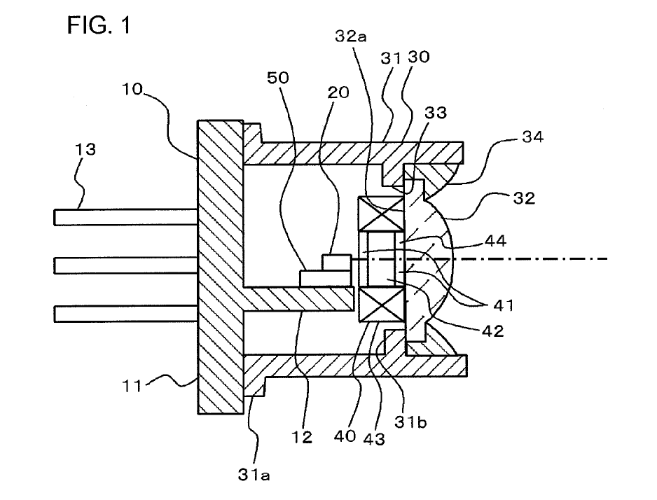

FIG. 1 is a sectional view of an optical transmission module according to a first embodiment.

The optical transmission module according to the present embodiment includes a stem 10, a semiconductor laser element 20 mounted over the stem 10, a cap 30 fixed to the stem 10 and hermetically sealing the semiconductor laser element 20, and an optical isolator 40 arranged on an optical path of light emitted from the semiconductor laser element 20, wherein the cap 30 includes a tubular body 31, one end side of which is fixed to the stem 10, and a light transmitting section (aspheric lens 32 in the present embodiment) located on the optical path while closing an opening 33 on the other end side of the body 31, and fixed to the body 31 so as to keep hermeticity with the body 31, and the optical isolator 40 is arranged inside an area hermetically sealed by the cap 30. Hereinafter, a detailed description will be made.

The optical transmission module according to the present embodiment is mounted in a small form factor pluggable (SFP), a bi-directional optical subassembly (BOSA), or the like.

The stem 10 includes a flat disk-like stem base 11, a stem block 12 integrally provided with the stem base 11 so as to erect from one surface of the stem base 11, and a plurality of leads 13 projecting from the other surface of the stem base 11.

A sub-mount 50 is fixed to the stem block 12.

The sub-mount 50 is a member obtained by forming a thin-film electrode pattern (circuit pattern), an AuSn thin film and the like on a base having high thermal conductivity and excellent thermal radiation properties, such as a ceramic substrate or a Si substrate. The AuSn thin film is, for example, formed on each side of the sub-mount 50. In this case, one AuSn thin film is used for soldering the semiconductor laser element 20 onto the sub-mount 50, and the other AuSn thin film is used for soldering the sub-mount 50 onto the stem block 12. Heat generated by the semiconductor laser element 20 is radiated to the stem 10 through the sub-mount 50. Further, the sub-mount 50 also serves as a buffering function to alleviate an adverse effect exerted by thermal stress that occurs due to a difference in thermal expansion coefficient between the stem 10 and the semiconductor laser element 20.

The semiconductor laser element 20 is fixed to the sub-mount 50. The semiconductor laser element 20 emits laser light (emitted light) from one end surface thereof. The semiconductor laser element 20 is arranged such that an orientation of this emitted light is orthogonal to the stem base 11.

In addition, the semiconductor laser element 20 is electrically connected with the leads 13 through a thin film electrode pattern of the sub-mount 50 and an electrode pattern formed on the stem block 12. When a predetermined electric signal is input into the leads 13, the semiconductor laser element 20 emits light from a light emitting surface. That is, the optical transmission module converts an electric signal to an optical signal.

As described above, the cap 30 includes the tubular body 31, and the aspheric lens 32 closing the opening 33 of the cap 30. That is, in the present embodiment, the cap 30 is a cap with a lens.

A flange-like flange portion 31a, which is fixed to the stem base 11, is formed at one end of the body 31. The flange portion 31a is fixed to the stem base 11 by resistance welding so that the body 31 is fixed to the stem 10. The reason for performing the resistance welding is to ensure hermeticity between the flange portion 31a and the stem base 11 so as to obtain high reliability.

A fixing portion 31b for fixing the aspheric lens 32 to the body 31 is formed on the other end side of the body 31. The fixing portion 31b is an annular portion projecting toward the center side of the body 31 (in the direction of making an inner diameter of the body 31 smaller). The body 31 has a smaller diameter in the fixing portion 31b than in the other portion.

The aspheric lens 32 has one surface being a flat surface 32a which is formed to be flat, and the other surface which is formed in convex curved shape. The aspheric lens 32 collects the light emitted from the semiconductor laser element 20. That is, in the present embodiment, the light transmitting section is a collecting lens formed so as to have one flat surface.

A diameter of the aspheric lens 32 is set larger than an inner diameter of the fixing portion 31b, and is set smaller than an inner diameter of a portion other than the fixing portion 31b in the body 31. The aspheric lens 32 is, for example, made of glass.

The aspheric lens 32 is fixed to the body 31 such that the flat surface 32a thereof faces the semiconductor laser element 20 side. More specifically, the flat surface 32a butts against the fixing portion 31b (butts against the right-side surface of the fixing portion 31b in FIG. 1).

Fixing of the aspheric lens 32 to the body 31 is preferably performed for example by bonding through a low-melting glass 34. Herein, the low-melting glass 34 is glass having a glass-transition point of the order equal to or less than 600 degrees centigrade. Fixing the aspheric lens 32 to the body 31 by use of the low-melting glass 34 can give high hermeticity between the body 31 and the aspheric lens 32. It should be noted that a melting point of the low-melting glass 34 is lower than that of the aspheric lens 32.

Herein, the semiconductor laser element 20 inside the optical transmission module is sensitive to a reflected return light, and an operation thereof becomes unstable when, in FIG. 1, the light emitted from the semiconductor laser element 20 is reflected on a light receiving surface of an optical fiber (not illustrated) or the other discontinuous interface and the returned light enters into the semiconductor laser element 20. In order to suppress entry of the reflected return light into the semiconductor laser element 20, the optical isolator 40 is built inside the optical transmission module according to the present embodiment.

The optical isolator 40 is an optical device having a function to allow only light in one direction to pass and block light in the opposite direction. The optical isolator 40 is configured having, for example, a pair of light polarizers 41, a faraday rotator 42 and a magnet 43. The faraday rotator 42 is placed between the pair of light polarizers 41. The pair of light polarizers 41 and the faraday rotator 42 constitute a unit 44. It is to be noted that a periphery of the unit 44 is laminated with an adhesive. Further, the magnet 43 is arranged around the unit 44 as thus laminated. The unit 44 is located on the optical path of the light emitted from the semiconductor laser element 20. Moreover, the optical isolator 40 may have a rutile single crystal in place of the light polarizer 41. Furthermore, the optical isolator 40 may be a type without the magnet 43.

The light polarizer 41 (or rutile single crystal) and the faraday rotator 42 of the optical isolator 40 are each formed by cutting out a plurality of pieces having a predetermined size from a large tabular material. Therefore, the smaller areas the light polarizer 41 (or rutile single crystal) and the faraday rotator 42 respectively have, the more pieces can be taken and the lower the cost become, and it is thus preferable to design the optical isolator 40 having a small area.

In the present embodiment, the optical isolator 40 is fixed to the flat surface 32a of the aspheric lens 32. That is, the optical isolator 40 is fixed to the surface (flat surface 32a) of the light transmitting section (aspheric lens 32) on the semiconductor laser element 20 side.

In order to prevent interference between the optical isolator 40 and the fixing portion 31b adjacent to the aspheric lens 32 on the semiconductor laser element 20 side, an outer shape of the optical isolator 40 is set smaller than the inner diameter of the fixing portion 31b. There exists a clearance between an inner periphery of the fixing portion 31b and an outer periphery of the optical isolator 40.

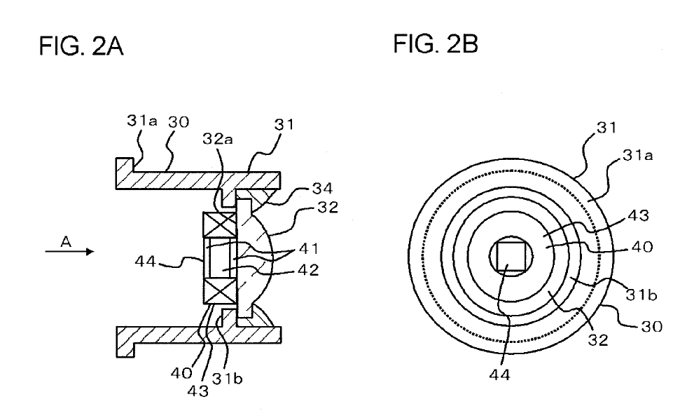

FIGS. 2A and 2B are views illustrating an arrangement of the optical isolator 40 with respect to the cap 30. FIG. 2A is a sectional view illustrating only the cap 30 and the optical isolator 40 extracted from the configuration illustrated in FIG. 1, and FIG. 2B is a view of the cap 30 and the optical isolator 40 seen in a direction of an arrow A of FIG. 2A.

As illustrated in FIG. 2B, in the present embodiment, for example, the magnet 43 is formed in tubular shape (cylindrical shape, for example), and the unit 44 made up of the pair of light polarizers 41 (or rutile single crystals) and the faraday rotator 42 (FIG. 2A) is inserted into a hollow inside the magnet 43.

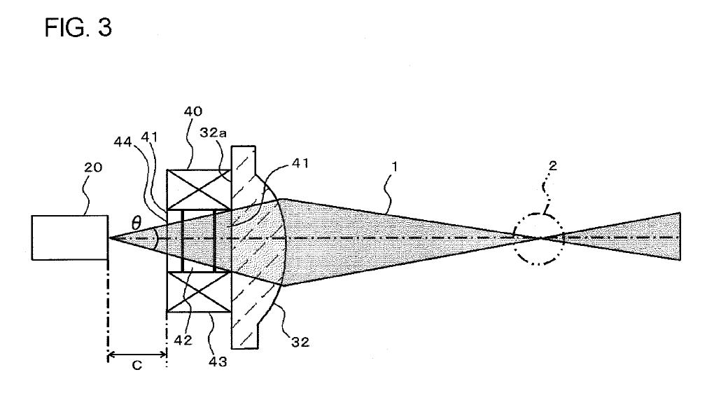

FIG. 3 is a view schematically illustrating an aspect of propagation of the light emitted from the semiconductor laser element 20.

In the present embodiment, the emitted light is incident on the aspheric lens 32 through the optical isolator 40, and collected by the aspheric lens 32. In FIG. 3, the optical path 1 of the emitted light is illustrated by gray shading.

The emitted light relatively drastically spreads (at a spreading angle of θ of FIG. 3) in a zone until it is collected by the aspheric lens 32, and the emitted light is relatively gently narrowed in a zone after it has been collected by the aspheric lens 32.

For this reason, the optical isolator 40 can be made smaller by arranging the optical isolator 40 on the semiconductor laser element 20 side with the aspheric lens 32 as a reference than by arranging the optical isolator 40 on the opposite side to the semiconductor laser element 20.

It should be noted that a clearance C (FIG. 3) between the light emitting surface (surface from which light is emitted) of the semiconductor laser element 20 and the optical isolator 40 is preferably from 0.14±0.12 mm, for example. The above clearance C is obtained from the following: 0.02 mm is preferably ensured at the minimum for the clearance C; and in the existing conditions, a mounting accuracy of the semiconductor laser element 20 is on the order of ±0.05 mm, a positional variation of the aspheric lens 32 with respect to the cap 30 is on the order of ±0.1 mm, a thickness variation of a resin (adhesive) which fixes the optical isolator 40 to the aspheric lens 32 is on the order of ±0.02 mm, and a root sum square of these is ±0.12 mm.

Next, a method for manufacturing an optical transmission module according to the present embodiment will be described. This manufacturing method includes mounting the semiconductor laser element 20 over the stem 10, fixing the cap 30 to the stem 10 and hermetically sealing the semiconductor laser element 20, and arranging the optical isolator 40 on the optical path of the light emitted from the semiconductor laser element 20. The cap 30 includes the tubular body 31, and the light transmitting section (aspheric lens 32, for example) which closes the opening 33 on one end side of the body 31 and is fixed to the body 31 so as to keep hermeticity with the body 31. The other end side of the body 31 is fixed to the stem 10 in the step of fixing the cap 30, and the optical isolator 40 is arranged inside an area hermetically sealed by the cap 30 in the step of arranging the optical isolator 40.

First, the semiconductor laser element 20 is mounted on the stem 10. More specifically, the sub-mount 50 is fixed onto the stem block 12 of the stem 10, and the semiconductor laser element 20 is fixed onto the sub-mount 50.

Meanwhile, the cap 30 is produced, and further, the optical isolator 40 is fixed to the flat surface 32a of the aspheric lens 32 of the cap 30.

Herein, the aspheric lens 32 is bonded to the body 31 through the low-melting glass 34, to produce the cap 30.

It is to be noted that the aspheric lens 32 may be bonded to the body 31 with an adhesive.

Meanwhile, the optical isolator 40 is bonded to the aspheric lens 32 through a thermosetting adhesive, for example. Herein, in the case of the optical isolator 40 being made up of the foregoing unit 44 and the magnet 43, it is preferable to first bond the unit 44 to the aspheric lens 32 and then bond the magnet 43 to the aspheric lens 32.

Next, by fixing the cap 30 to the stem 10, the semiconductor laser element 20 is hermetically sealed by the cap 30, while the optical isolator 40 is arranged on the optical path of the light emitted from the semiconductor laser element 20.

In this manner, the optical transmission module is obtained.

Next, an operation will be described.

When an electric signal is input into the leads 13, the semiconductor laser element 20 converts the electric signal to an optical signal and then outputs the signal. The emitted light (optical signal) output from the semiconductor laser element 20 is incident on the aspheric lens 32 through the optical isolator 40, and the light is collected by the aspheric lens 32 and output outside the cap 30.

Since the optical isolator 40 is arranged inside the area hermetically sealed by the cap 30, the semiconductor laser element 20 and the optical isolator 40 are close to each other as compared with the case of the optical isolator 40 being arranged outside the cap 30. Then, during the course of spreading of the light having been emitted at a spreading angle θ, the optical isolator 40 receives the emitted light. Therefore, as compared with the case of the optical isolator 40 being arranged outside the cap 30, an area of the optical isolator 40 can be made small. Consequently, it is possible to suppress an increase in cost of the optical isolator 40, and cost of the optical transmission module.

Herein, in Japanese Laid-open patent publication NO. 2004-061870, the cap is hermetically sealed by the optical isolator, but in this structure, when the optical isolator is bonded to the cap by use of low-melting glass for hermetical sealing, the function of the optical isolator may be lost under an influence of heat at the time of melting of the low-melting glass. Or possibly, the optical isolator may be damaged by a difference in linear expansion coefficient between the optical isolator and the low-melting glass. Moreover, when the optical isolator has a magnet, characteristics of the magnet may also deteriorate due to the heat. Additionally, when the optical isolator is applied with a transverse load (load in a direction orthogonal to a traveling direction of the emitted light) from the low-melting glass or the other adhesive layer, characteristics of the optical isolator may change (deteriorate) due to a photo-elastic effect. As thus described, in the structure of Japanese Laid-open patent publication NO. 2004-061870, a variety of adverse effects are exerted, such as deterioration in characteristics of the optical isolator caused by hermetical sealing by the optical isolator.

As opposed to this, in the present embodiment, since the optical isolator 40 is arranged inside the area hermetically sealed by the cap 30, hermetical sealing need not be performed by the optical isolator 40. Therefore, it is possible to prevent exertion of the variety of adverse effects, such as deterioration in characteristics of the optical isolator 40 caused by the optical isolator 40 performing hermetical sealing.

According to the first embodiment as thus described, since the optical isolator 40 is arranged inside the area hermetically sealed by the cap 30, the area of the optical isolator 40 can be made small as compared with the case of the optical isolator 40 being arranged outside the cap 30. Consequently, it is possible to suppress an increase in cost of the optical isolator 40, and cost of the optical transmission module. Furthermore, it is possible to prevent exertion of the variety of adverse effects, such as deterioration in characteristics of the optical isolator 40 caused by the optical isolator 40 performing hermetical sealing.

Moreover, the optical isolator 40 is fixed to the surface (flat surface 32a) of the light transmitting section (aspheric lens 32) on the semiconductor laser element 20 side. More specifically, the light transmitting section is a collecting lens (aspheric lens 32) formed so as to have one flat surface, and the optical isolator 40 is fixed to the flat surface 32a. That is, an end surface of the optical isolator 40 in a direction parallel to the optical path of the light emitted from the semiconductor laser element 20 is bonded to any place inside the area hermetically sealed by the cap 30 so the optical isolator 40 is fixed.

It is thereby possible to realize a structure in which the optical isolator 40 is not substantially applied with the transverse load (load in the direction orthogonal to the traveling direction of the emitted light) by an adhesive or the like. Hence it is possible to suppress the change (deterioration) in characteristics of the optical isolator 40 due to the photo-elastic effect.

Moreover, alignment (optical-axis adjustment) can be performed after the optical isolator 40 has been incorporated into the cap 30, thereby to facilitate assembly of the optical transmission module.

Furthermore, in the present embodiment, the lens (aspheric lens 32) is integrally provided with the cap 30, and it is thereby possible to make a length of the optical transmission module (length in the traveling direction of the emitted light) small, as compared with later-mentioned fourth to sixth embodiments.

### Second Embodiment

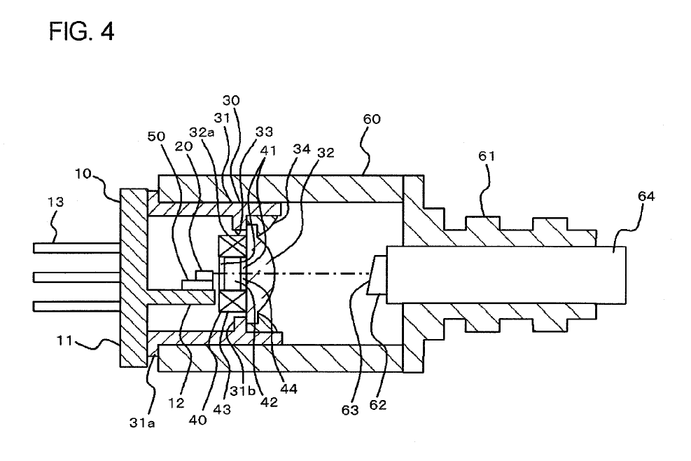

FIG. 4 is a sectional view of an optical transmission module according to a second embodiment. The optical transmission module according to the present embodiment has an external holder 60, a fiber support 61, a holder 64 and a ferrule 62 with an optical fiber, on top of the structure of the optical transmission module (FIG. 1) according to the first embodiment.

The external holder 60 is formed in tubular shape (cylindrical shape, for example), and the body 31 of the cap 30 is fitted into one axial part (left-half section of FIG. 4, for example) of the external holder 60. Further, one end surface of the external holder 60 butts against the flange portion 31a.

The fiber support 61 is fixed to the other end surface of the external holder 60. The holder 64 is fitted into the fiber support 61. The ferrule 62 with an optical fiber is fixed inside the holder 64.

The ferrule 62 with an optical fiber holds an optical fiber (not illustrated) inside. The tip surface of the optical fiber is exposed to a light receiving surface 63 as one end surface of the ferrule 62 with an optical fiber.

The external holder 60 is previously fixed to the cap 30, and thereafter, the ferrule 62 with an optical fiber is aligned such that the light receiving surface 63 is arranged in the vicinity of a collected position 2 of light illustrated in FIG. 3. In such an aligned state, the fiber support 61 is fixed to the external holder 60 by Yttrium Aluminum Garnet (YAG) welding or the like. Hence the semiconductor laser element 20 is optically coupled with the optical fiber inside the ferrule 62 with an optical fiber through the optical isolator 40 and the aspheric lens 32.

Also by the second embodiment as thus described, it is possible to obtain a similar effect to that by the first embodiment.

It should be noted that in the case of the structure of Japanese Laid-open patent publication NO. 2007-086472, the optical isolator is arranged outside the cap, and therefore, for example at the time of fixing an external holder to the cap for the purpose of fixing the ferrule with an optical fiber, it is necessary to cautiously perform an operation so as not to inadvertently touch the optical isolator, thereby causing damage on a bonded surface of the optical isolator. As opposed to this, in the present embodiment, the optical isolator 40 is arranged inside the area hermetically sealed by the cap 30, thereby facilitating handling at the time of fixing the external holder 60 to the cap 30 for the purpose of fixing the ferrule 62 with an optical fiber.

### Third Embodiment

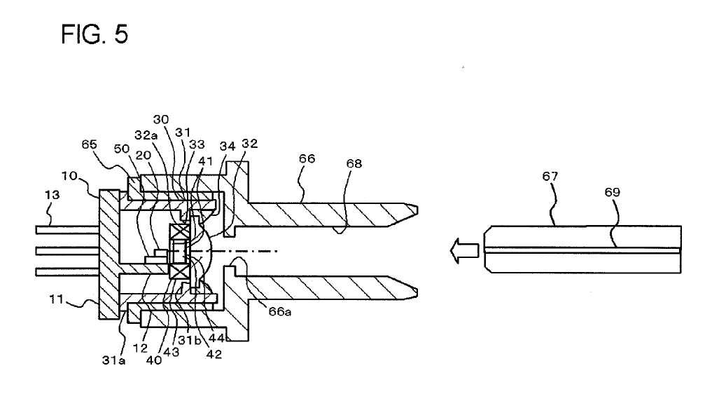

FIG. 5 is a sectional view of an optical transmission module according to a third embodiment. The optical transmission module according to the present embodiment has a receptacle 66, on top of the structure of the optical transmission module (FIG. 1) according to the first embodiment.

The receptacle 66 is fixed to an outer peripheral surface of the body 31 of the cap 30 through a binder (adhesive, for example) 65. The receptacle 66 is a member generally used for inserting and fixing a ferrule 67 with an optical fiber, and the ferrule 67 with an optical fiber can be inserted into and withdrawn from an insertion/fixing portion 68 of the receptacle 66.

The ferrule 67 with an optical fiber is called a plug ferrule, and holds an optical fiber 69 inside. By insertion and fixing of the ferrule 67 with an optical fiber into the receptacle 66, the optical fiber 69 is optically coupled with the semiconductor laser element 20 through the opening 66a of the receptacle 66, the aspheric lens 32 and the optical isolator 40.

Also by the third embodiment as thus described, it is possible to obtain a similar effect to that by the first embodiment.

Further, the optical isolator 40 is arranged inside the area hermetically sealed by the cap 30, thereby facilitating handling at the time of fixing the receptacle 66 to the cap 30.

### Fourth Embodiment

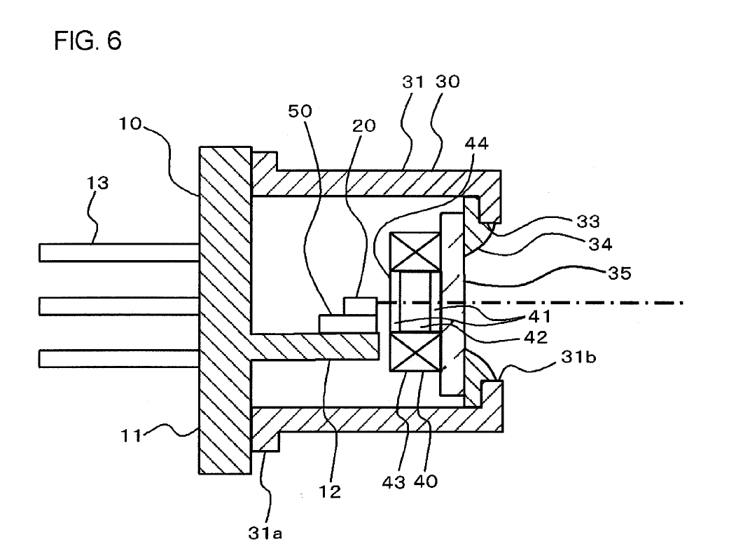

FIG. 6 is a sectional view of an optical transmission module according to a fourth embodiment. The optical transmission module according to the present embodiment is different from the above first embodiment in the structure of the cap 30, and in the other respects, it is configured as in the first embodiment.

In the present embodiment, the cap 30 has a plain window 35 instead of having the aspheric lens 32. That is, in the present embodiment, the cap 30 is a plain window cap. The plain window 35 is made up of a transparent material such as glass, and each surface thereof is formed to be flat.

Further, in the present embodiment, the fixing portion 31b of the body 31 is formed at the end of the body 31 on the opposite side to the end thereof where the flange portion 31a is formed.

The plain window 35 is bonded to the fixing portion 31b through the low-melting glass 34. Thereby, hermeticity between the plain window 35 and the body 31 is kept. The optical isolator 40 is fixed to one surface (surface on the semiconductor laser element 20 side) of the plain window 35. Also in the present embodiment, the optical isolator 40 is fixed with the thermosetting adhesive, for example.

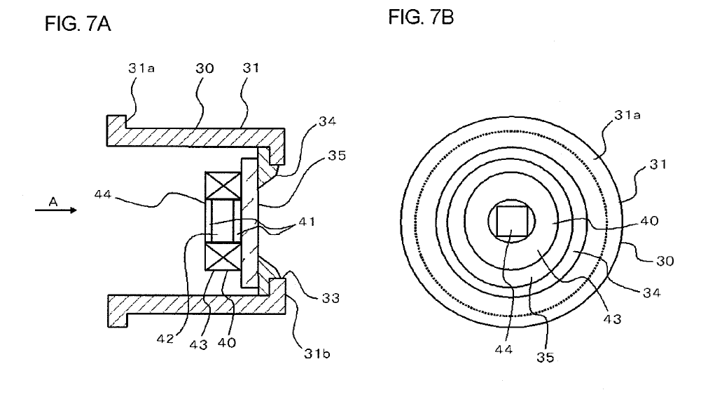

FIGS. 7A and 7B are views illustrating an arrangement of the optical isolator 40 with respect to the cap 30. Herein, FIG. 7A is a sectional view illustrating only the cap 30 and the optical isolator 40 extracted from the configuration illustrated in FIG. 6, and FIG. 7B is a view of the cap 30 and the optical isolator 40 seen in a direction of an arrow A of FIG. 7A. Also in the present embodiment, the optical isolator 40 is configured as in the first embodiment. How to fix the optical isolator 40 to the plain window 35 is similar to the method for fixing the optical isolator 40 to the aspheric lens 32 in the first embodiment. Further, the clearance C between the light emitting surface of the semiconductor laser element 20 and the optical isolator 40 is similar to that in the first embodiment.

It is to be noted that in the present embodiment, a lens (not illustrated) which collects the light emitted from the semiconductor laser element 20 onto an external optical fiber (not illustrated) is arranged outside the cap 30.

Also by the fourth embodiment as thus described, it is possible to obtain a similar effect to that by the first embodiment.

Further, in the present embodiment, since the lens is arranged separately from the cap 30, the flexibility in designing the lens is high as compared with the above first to third embodiments. Moreover, as a result of this, cost reduction can also be expected.

### Fifth Embodiment

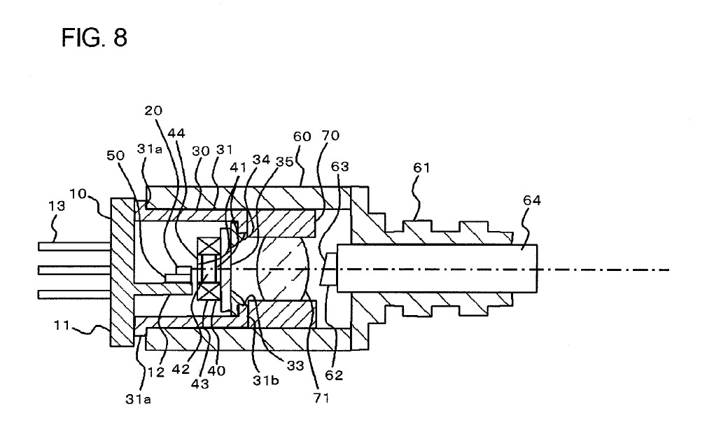

FIG. 8 is a sectional view of an optical transmission module according to a fifth embodiment. The optical transmission module according to the present embodiment has the external holder 60, the fiber support 61, the holder 64, the ferrule 62 with an optical fiber, a lens holder 70 and a lens 71, on top of the structure of the optical transmission module (FIG. 6) according to the fourth embodiment.

The external holder 60, the fiber support 61, the holder 64 and the ferrule 62 with an optical fiber are similar to those in the above second embodiment.

The lens holder 70 is formed in cylindrical shape, and fixed to an inner periphery of the external holder 60. Further, the lens 71 is fixed to an inner periphery of the lens holder 70.

In the present embodiment, the semiconductor laser element 20 is optically coupled with the optical fiber in the ferrule 62 with an optical fiber through the optical isolator 40, the plain window 35 and the lens 71.

Also by the fifth embodiment as thus described, it is possible to obtain a similar effect to that by the fourth embodiment.

Further, by making an appropriate change in the lens 71, it is possible to change an optimal position for the ferrule 62 with an optical fiber to receive light, so as to change a total length of the optical transmission module as requested. Further, in the present embodiment, the lens 71 has respective curved faces on two faces, the front and back surfaces, thereby enhancing the flexibility in designing. Moreover, since the ability to collect the light emitted from the semiconductor laser element 20 is high as compared with the case of one curved surface being provided, it is also possible to further enhance the efficiency in optical transmission to the optical fiber in the ferrule 62 with an optical fiber.

### Sixth Embodiment

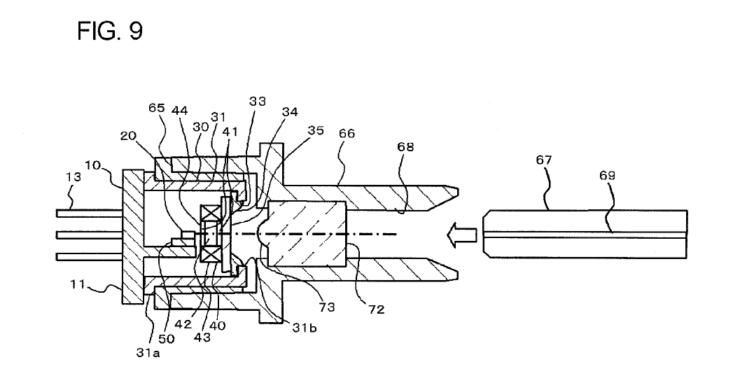

FIG. 9 is a sectional view of an optical transmission module according to a sixth embodiment. The optical transmission module according to the present embodiment has the receptacle 66, on top of the structure of the optical transmission module (FIG. 6) according to the fourth embodiment.

A transparent member 72 is integrally provided in the receptacle 66, and the transparent member 72 has a lens 73. In addition, the receptacle 66 is made up of metal or resin, and the transparent member 72 is made up of resin or glass.

The receptacle 66 is fixed to an outer peripheral surface of the body 31 of the cap 30 through a binder (adhesive, for example) 65. The ferrule 67 with an optical fiber can be inserted into and withdrawn from the insertion/fixing portion 68 of the receptacle 66.

By insertion and fixing of the ferrule 67 with an optical fiber into the insertion/fixing portion 68 of the receptacle 66, the optical fiber 69 is optically coupled with the semiconductor laser element 20 through the transparent member 72, the lens 73 thereof, the plain window 35 and the optical isolator 40.

Also by the sixth embodiment as thus described, it is possible to obtain a similar effect to that by the fourth embodiment.

Further, since the receptacle 66 is configured to include the lens 73, it is possible to reduce the number of components as compared with the case of the lens being separately formed, so as to reduce the cost of the optical transmission module.

### Seventh Embodiment

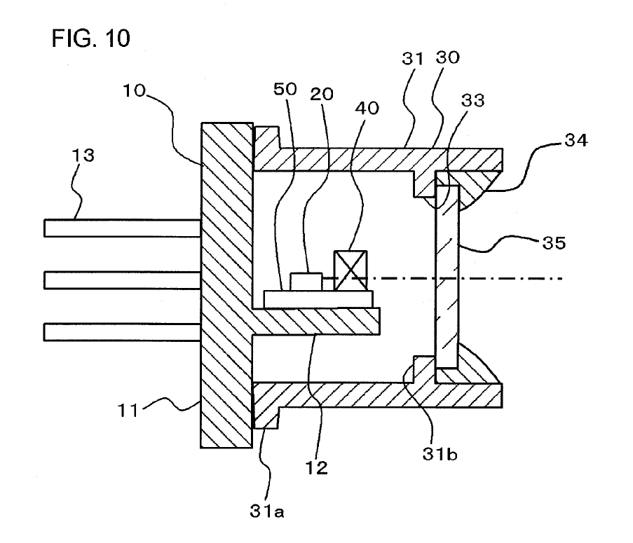

FIG. 10 is a sectional view of an optical transmission module according to a seventh embodiment. The optical transmission module according to the present embodiment is different from the above fourth embodiment in that the optical isolator 40 is arranged on the sub-mount 50, and in the other respects, it is configured as in the fourth embodiment.

Since the optical isolator 40 may deteriorate in its function when exposed to a high temperature, for fixing the optical isolator 40 to the sub-mount 50, there can be cited a method where the semiconductor laser element 20 is soldered onto the sub-mount 50 through an AuSn thin film, and the sub-mount 50 is soldered onto the stem block 12 of the stem 10 through another AuSn thin film, and thereafter, the optical isolator 40 is fixed to the sub-mount 50 with the thermosetting adhesive.

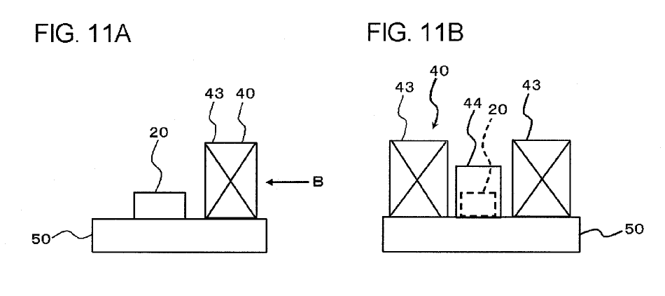

FIGS. 11A and 11B are views illustrating an example of arrangements of the optical isolator 40 with respect to a sub-mount 50, wherein FIG. 11A is a side view, and FIG. 11B is a view of the sub-mount 50 and the optical isolator 40 seen in a direction of an arrow B of FIG. 11A.

In the present embodiment, as illustrated in FIGS. 11A and 11B, the optical isolator 40 is, for example, configured by arranging a pair of magnets 43 on both sides of the unit 44 made up of the pair of light polarizers 41 (or rutile single crystals) and the faraday rotator 42 (see FIG. 2A). That is, the unit 44 and the pair of magnets 43 are respectively fixed onto the sub-mount 50. This unit 44 is located on the optical path of the light emitted from the semiconductor laser element 20. It is to be noted that in the present embodiment, an example is represented where the surface of the sub-mount 50, on which the optical isolator 40 and the semiconductor laser element 20 is mounted, is flat.

In the present embodiment, the clearance C between the light emitting surface of the semiconductor laser element 20 and the unit 44 of the optical isolator 40 is preferably from 0.09±0.07 mm, for example. The above clearance C is obtained from the following: 0.02 mm is preferably ensured at the minimum for the clearance C; and in the existing conditions, a mounting accuracy of the semiconductor laser element 20 is on the order of ±0.05 mm, a mounting accuracy of the optical isolator 40 is also on the order of ±0.05 mm, and a root sum square of these is ±0.07 mm.

According to the present embodiment, it is possible to obtain a similar effect to that by the first embodiment, and besides, since the optical isolator 40 is mounted on the sub-mount 50, it is also possible to bring the semiconductor laser element 20 and the optical isolator 40 further closer to each other than in each of the above embodiments. Hence it is possible to make the area of the optical isolator 40 further smaller than in each of the above embodiments, so as to reduce the cost of the optical isolator 40 furthermore than in each of the above embodiments.

In addition, in the unit 44 including the pair of light polarizers 41 (or rutile single crystals) and the faraday rotator 42, one end surface (lower surface of FIG. 10) is fixed onto the sub-mount 50 through the thermosetting adhesive, whereas the surface other than the one surface is open (not fixed). This can suppress deformation of the unit 44 due to application of a transverse load to the unit 44, thereby preventing substantial occurrence of a change in characteristics of the optical isolator 40 due to such a photo-elastic effect as described above.

### Eighth Embodiment

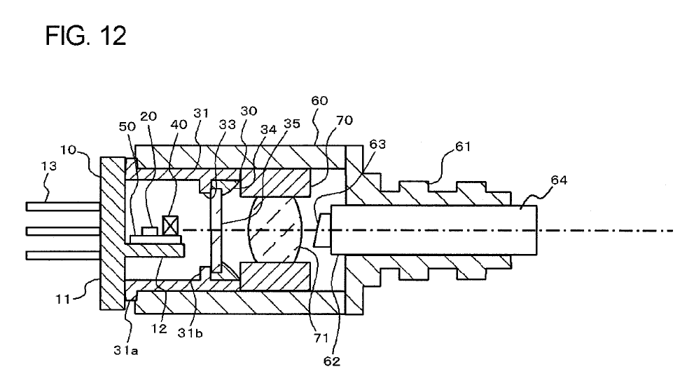

FIG. 12 is a sectional view of an optical transmission module according to an eighth embodiment. The optical transmission module according to the present embodiment includes the external holder 60, the fiber support 61, the holder 64, the ferrule 62 with an optical fiber, the lens holder 70 and the lens 71, on top of the structure of the optical transmission module (FIG. 10) according to the seventh embodiment.

The external holder 60, the fiber support 61, the holder 64, the ferrule 62 with an optical fiber, the lens holder 70 and the lens 71 are similar to those in the above fifth embodiment.

In the present embodiment, the semiconductor laser element 20 is optically coupled with the optical fiber in the ferrule 62 with an optical fiber through the optical isolator 40, the plain window 35 and the lens 71.

Also by the eighth embodiment as thus described, it is possible to obtain a similar effect to that by the seventh embodiment.

### Ninth Embodiment

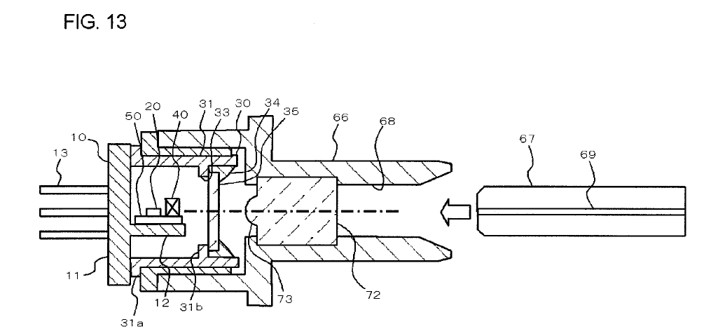

FIG. 13 is a sectional view of an optical transmission module according to a ninth embodiment. The optical transmission module according to the present embodiment has the receptacle 66, on top of the structure of the optical transmission module (FIG. 10) according to the seventh embodiment.

The receptacle 66 is similar to that in the sixth embodiment. By insertion and fixing of the ferrule 67 with an optical fiber into the insertion/fixing portion 68 of the receptacle 66, the optical fiber 69 is optically coupled with the semiconductor laser element 20 through the transparent member 72, the lens 73 thereof, the plain window 35 and the optical isolator 40.

Also by the ninth embodiment as thus described, it is possible to obtain a similar effect to that by the seventh embodiment.

### First Modification

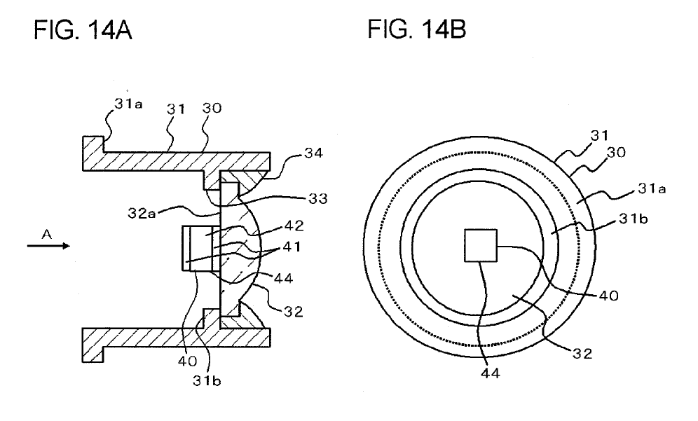

FIGS. 14A and 14B are views for explaining an optical transmission module according to a first modification. Herein, FIG. 14A is a sectional view illustrating only the cap 30 and the optical isolator 40 of the optical transmission module according to the first modification, and FIG. 14B is a view of the cap 30 and the optical isolator 40 seen in a direction of an arrow A of FIG. 14A. Although the example was described in each of the above first to third embodiments where the optical isolator 40 of the type having the magnet 43 is fixed to the aspheric lens 32, the optical isolator 40 of the type not having the magnet 43 may be fixed to the flat surface 32a of the aspheric lens 32, as illustrated in FIGS. 14A and 14B.

### Second Modification

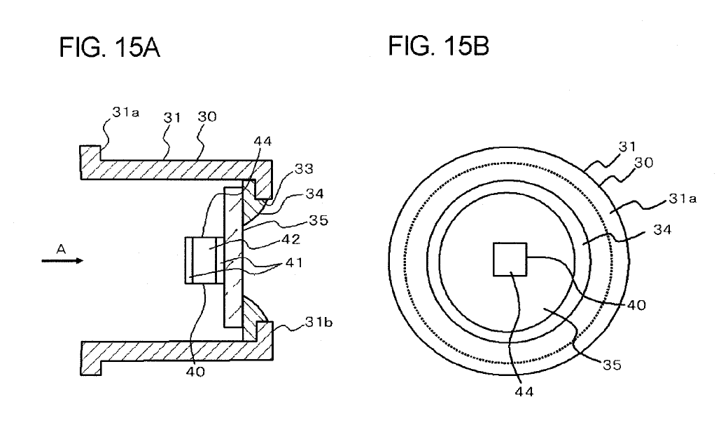

FIGS. 15A and 15B are views for explaining an optical transmission module according to a second modification. Herein, FIG. 15A is a sectional view illustrating only the cap 30 and the optical isolator 40 of the optical transmission module according to the second modification, and FIG. 15B is a view of the cap 30 and the optical isolator 40 seen in a direction of an arrow A of FIG. 15A. Although the example was described in each of the above fourth to sixth embodiments where the optical isolator 40 of the type having the magnet 43 is fixed to the plain window 35, the optical isolator 40 of the type not having the magnet 43 may be fixed to one surface of the plain window 35, as illustrated in FIGS. 15A and 15B.

### Third Modification

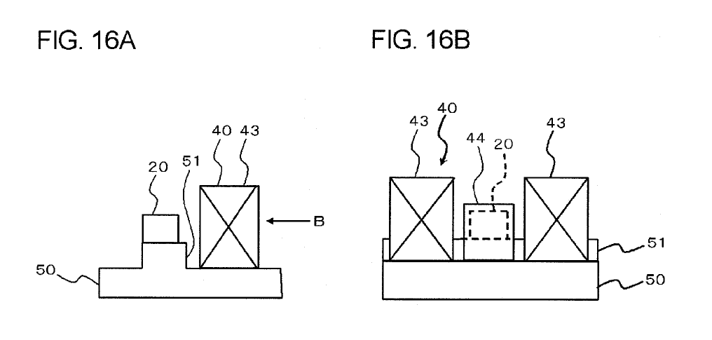

FIGS. 16A and 16B are views for explaining an optical transmission module according to a third modification. Herein, FIG. 16A is a side view illustrating only the sub-mount 50, the semiconductor laser element 20 and the optical isolator 40 of the optical transmission module according to the third modification, and FIG. 16B is a view of the sub-mount 50 and the optical isolator 40 seen in a direction of an arrow B of FIG. 16A. Although the example was described in each of the above seventh to ninth embodiments where the upper surface of the sub-mount 50 is flat, a step 51 is formed on the upper surface of the sub-mount 50, to arrange the semiconductor laser element 20 on an upper level than the optical isolator 40 in the third modification, as illustrated in FIGS. 16A and 16B. In addition, it is preferable to make the light emitting surface of the semiconductor laser element 20 opposed to the central section of the optical isolator 40. As thus described, the light emitted from the semiconductor laser element 20 spreads at a predetermined spreading angle θ, and with such an arrangement made, it is possible to more efficiently allow the emitted light to be incident on the optical isolator 40 than in the above seventh to ninth embodiments, so as to enhance the usage efficiency of the emitted light.

### Fourth Modification

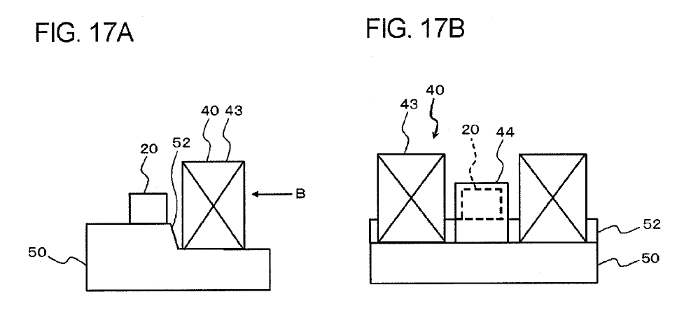

FIGS. 17A and 17B are views for explaining an optical transmission module according to a fourth modification. Herein, FIG. 17A is a side view illustrating only the sub-mount 50, the semiconductor laser element 20 and the optical isolator 40 of the optical transmission module according to the fourth modification, and FIG. 17B is a view of the sub-mount 50 and the optical isolator 40 seen in a direction of an arrow B of FIG. 17A. Although the example was described in the above third modification where the step 51 was formed on the upper surface of the sub-mount 50, an inclined surface 52 is formed on the upper surface of the sub-mount 50 in the fourth modification. This inclined surface 52 is declivous from the arrangement area of the semiconductor laser element 20 toward the arrangement area of the optical isolator 40. In addition, it is preferable to make the light emitting surface of the semiconductor laser element 20 opposed to the central section of the optical isolator 40. As thus described, the light emitted from the semiconductor laser element 20 spreads at a predetermined spreading angle θ, and with such an arrangement made, it is possible to more efficiently allow the emitted light to be incident on the optical isolator 40 than in the above third modification, so as to enhance the usage efficiency of the emitted light.

### Fifth Modification

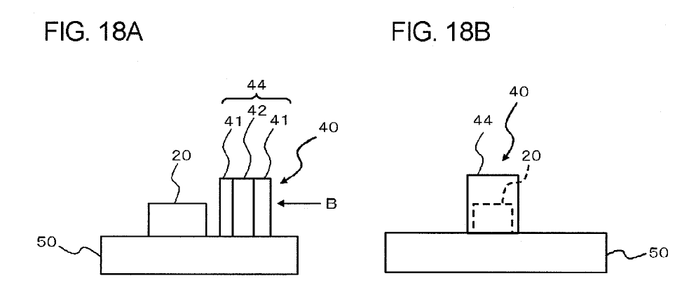

FIGS. 18A and 18B are views for explaining an optical transmission module according to a fifth modification. Herein, FIG. 18A is a side view illustrating only the sub-mount 50, the semiconductor laser element 20 and the optical isolator 40 of the optical transmission module according to the fifth modification, and FIG. 18B is a view of the sub-mount 50 and the optical isolator 40 seen in a direction of an arrow B of FIG. 18A. Although the example was described in each of the above seventh to ninth embodiments where the optical isolator 40 of the type having the magnet 43 is mounted on the sub-mount 50, the optical isolator 40 of the type not having the magnet 43 may be mounted on the sub-mount 50, as illustrated in FIGS. 18A and 18B.

### Sixth Modification

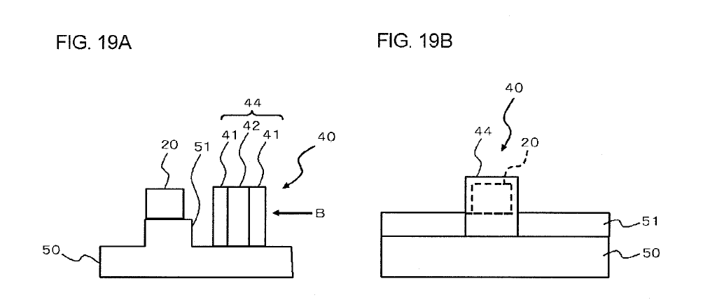

FIGS. 19A and 19B are views for explaining an optical transmission module according to a sixth modification. Herein, FIG. 19A is a side view illustrating only the sub-mount 50, the semiconductor laser element 20 and the optical isolator 40 of the optical transmission module according to the sixth modification, and FIG. 19B is a view of the sub-mount 50 and the optical isolator 40 seen in a direction of an arrow B of FIG. 19A. Although the example was described in the above third modification where the optical isolator 40 of the type having the magnet 43 is mounted on the sub-mount 50 having the step 51, the optical isolator 40 of the type not having the magnet 43 may be mounted on the sub-mount 50 having the step 51, as illustrated in FIGS. 19A and 19B.

### Seventh Modification

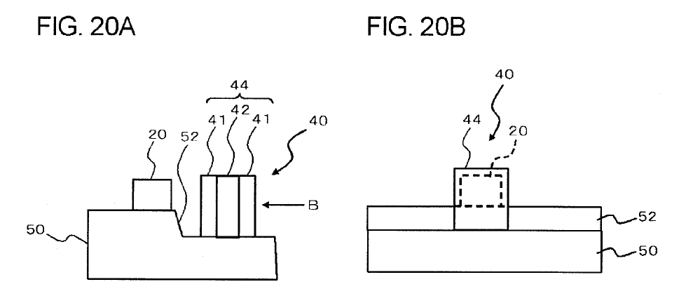

FIGS. 20A and 20B are views for explaining an optical transmission module according to a seventh modification. Herein, FIG. 20A is a side view illustrating only the sub-mount 50, the semiconductor laser element 20 and the optical isolator 40 of the optical transmission module according to the seventh modification, and FIG. 20B is a view of the sub-mount 50 and the optical isolator 40 seen in a direction of an arrow B of FIG. 20A. Although the example was described in the above fourth modification where the optical isolator 40 of the type having the magnet 43 is mounted on the sub-mount 50 having the inclined surface 52, the optical isolator 40 of the type not having the magnet 43 may be mounted on the sub-mount 50 having the inclined surface 52, as illustrated in FIGS. 20A and 20B.

It is apparent that the present invention is not limited to the above embodiment, and may be modified and changed without departing from the scope and spirit of the invention.

What is claimed is:

1. An optical transmission module, comprising:
a stem;
a semiconductor laser element mounted over the stem;
a cap fixed to the stem and hermetically sealing the semiconductor laser element; and
an optical isolator arranged on an optical path of light emitted from the semiconductor laser element,
wherein the cap includes;
a tubular body, one end side of which is fixed to the stem, and
a light transmitting section located on the optical path while closing an opening on the other end side of the body, and fixed to the body so as to keep hermeticity with the body, and
the optical isolator is arranged inside an area hermetically sealed by the cap.

2. The optical transmission module according to claim 1, wherein the optical isolator is fixed to a surface of the light transmitting section on the semiconductor laser element side.

3. The optical transmission module according to claim 2, wherein
the light transmitting section is a collecting lens, one surface of which is formed to be flat, and
the optical isolator is fixed to the flat surface of the collecting lens.

4. The optical transmission module according to claim 2, wherein the light transmitting section is a flat plain window each surface of which are flat.

5. The optical transmission module according to claim 1, further comprising a sub-mount fixed to the stem,
wherein the semiconductor laser element and the optical isolator are fixed to the sub-mount.

6. The optical transmission module according to claim 1, wherein an end surface of the optical isolator in a direction parallel to the optical path is bonded to any place inside the area hermetically sealed by the cap so that the optical isolator is fixed.

7. The optical transmission module according to claim 1, further comprising:
a holder member fixed to the cap; and
a ferrule with an optical fiber, holding an optical fiber inside and fixed to the holder member,
wherein the semiconductor laser element is optically coupled with the optical fiber of the ferrule with an optical fiber.

8. The optical transmission module according to claim 1, further comprising a receptacle fixed to the cap.

9. A method for manufacturing an optical transmission module, comprising:
mounting a semiconductor laser element over a stem;
fixing a cap to the stem and hermetically sealing the semiconductor laser element; and
arranging an optical isolator on an optical path of light emitted from the semiconductor laser element,
wherein the cap includes a tubular body, and a light transmitting section which closes an opening on one end side of the body and is fixed to the body so as to keep hermeticity with the body,
the other end side of the body is fixed to the stem in said fixing the cap, and
the optical isolator is arranged inside an area hermetically sealed by the cap in said arranging the optical isolator.
